(19) United States
(12) Patent Application Publication
(10) Pub. No.: US 2008/0010070 A1
(43) Pub. Date: Jan. 10, 2008

(54) Spoken dialog system for human-computer interaction and response method therefor

(76) Inventors: Sanghun Kim, Yuseong-gu (KR); Seung-Shin Oh, Yuseong-gu (KR); Seung Yun, Yuseong-gu (KR); Kyoung Hyun Park, Yuseong-gu (KR)

Correspondence Address: LADAS & PARRY LLP, 224 SOUTH MICHIGAN AVENUE, SUITE 1600, CHICAGO, IL, 60604, US

(21) Appl. No.: 11/651,261

(22) Filed: Jan. 9, 2007

(30) Foreign Application Priority Data
Jul. 10, 2006 (KR) 10-2006-0064484

(51) Int. Cl. G10L 13/00

(52) U.S. Cl. 704/259

(57) ABSTRACT

A spoken dialog system comprises a speech recognition unit for recognizing a user's input speech to generate a character sequence corresponding thereto; a sentence contents database for storing therein a plurality of sentence contents; a knowledge search unit for searching through the sentence contents to find a match for the character sequence, in the sentence contents database; a dialog model unit for delivering the character sequence to the knowledge search unit to receive the sentence contents therefrom, and setting a dialog model by using the sentence contents; a system response unit for generating an output sentence which harmonizes with the user's input speech or expresses a situation of the system; and a speech synthesis unit for converting the output sentence into the output speech.

### FIELD OF THE INVENTION

The present invention relates to a spoken dialog system and a method for generating a response in the system; and, more particularly, to a spoken dialog system for realizing a natural dialog between an user and the system and a response method therefor, by generating an output sentence which concords with user's intention and a situation of the system, in the spoken dialog system with a speech interface based on HCI (Human-Computer Interaction).

### BACKGROUND OF THE INVENTION

HCI is a relatively new field, and its main focus is generally on designing an easy to use computer system. The basic concepts of HCI get materialized during a developing process of a user-centered computer system, rather than that of developer-centered one. Further, it mainly deals with a designing-evaluating-completing process of a computer operating system for interaction with humans.

On one hand, such a typical spoken dialog system based on HCI is applied to systems such as a brainy robot, a telematics system, a digital home, and the like, all aimed at performing, for example, a weather search, a schedule management, a news search, a TV program guide, an email management, etc.

The spoken dialog system applied to these systems generates the output sentence by performing one of the followings: using an interactive information search service, wherein a large amount of dialog examples having sets, each set including a user's intention and a situation of the system responding to the user's intention, is employed; filling a sentence template stored in a pre-built sentence template database with sentence contents which may correspond to search results from a separate database; generating a literary sentence based on a system grammar via a natural language processing such as a construction generation, a morpheme generation, a text generation, and the like.

FIG. 1 is a schematic view showing a conventional spoken dialog system.

As shown in FIG. 1, such a conventional spoken dialog system based on the HCI includes, for example, a speech recognition unit 10, a dialog model unit 12, a knowledge search unit 14, a sentence contents database 16, and a speech synthesis unit 18.

The speech recognition unit 10 performs a speech recognition and delivers a character sequence corresponding to the recognized speech to the dialog model unit 12. The speech recognition includes a process of detecting a user's input speech; a process of amplifying the speech detected to a specific level; a process of extracting feature parameters from the speech; and other processes necessary to perform the speech recognition.

The dialog model unit 12 delivers the character sequence recognized by the speech recognition unit 10 to the knowledge search unit 14. Further, the dialog model unit 12 generates an output sentence as a response to the user by using sentence contents received from the knowledge search unit 14.

The sentence contents database 16 stores therein a number of sentence contents to be used for a user response sentence, for examples including a weather search, a schedule management, a news search, a TV program guide, an email management, etc.

The knowledge search unit 14, in response to the character sequence from the dialog model unit 12, searches through the sentence contents stored in the sentence contents database 16 to find a match for the character sequence.

The speech synthesis unit 18 converts the output sentence generated by the dialog model unit 12 into an output speech before providing it to the user.

Since the main object of the conventional spoken dialog system configured in the aforementioned manner is to deliver information, the system is configured to clearly deliver the information therefrom, i.e., the output sentence, to the user audibly.

However, since such conventional spoken dialog system only uses a pattern matching, there may occasionally be discrepancies between the intention of the user and the output sentence generated. In order to attain a natural dialog between the user and the system as if it were made between persons, the output sentence is required to be corresponded with the intention of the user and reflect the situation of the system while delivering the information requested by the user. However, the conventional spoken dialog system has the following drawback: a natural dialog cannot be realized because the output sentence cannot be accurately corresponded with the intention of the user in detail and the situation of the system (e.g., a manner of the speaker to the dialog made) cannot be reflected in the system response.

### SUMMARY OF THE INVENTION

It is, therefore, an object of the present invention to provide a spoken dialog system for realizing an interactive speech interface as natural as a dialog between persons by generating an output sentence corresponding with the intention of the user and reflects the situation of the system, and a response method therein.

In accordance with one aspect of the present invention, there is provided a spoken dialog system, the system including:

a speech recognition unit for recognizing a user's input speech to generate a character sequence corresponding thereto;

a sentence contents database for storing therein a plurality of sentence contents;

a knowledge search unit for searching through the sentence contents stored to find a match for the character sequence, in the sentence contents database;

a dialog model unit for delivering the character sequence to the knowledge search unit to receive the sentence contents therefrom, and setting a dialog model by using the sentence contents;

a system response unit for generating an output sentence which harmonizes with the user's input speech or expresses a situation of the system; and

a speech synthesis unit for converting the output sentence into an output speech.

In accordance with another aspect of the present invention, there is provided a method for generating a response in a spoken dialog system, the method including the steps of:

recognizing a user's input speech to generate a character sequence corresponding thereto;

searching through sentence contents to fine a match for the character sequence;

setting a dialog model by using the sentence contents searched;

generating an output sentence which harmonizes with the user's input speech or expresses a situation of the system; and

converting the output sentence into an output speech.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic view showing a conventional spoken dialog system;

FIG. 2 provides a schematic view showing a spoken dialog system in accordance with the present invention;

FIG. 3 describes a detail view showing a system response unit of the spoken dialog system in accordance with the present invention; and

FIGS. 4A and 4B depict a flow chart showing a system response method of the spoken dialog system in accordance with the present invention.

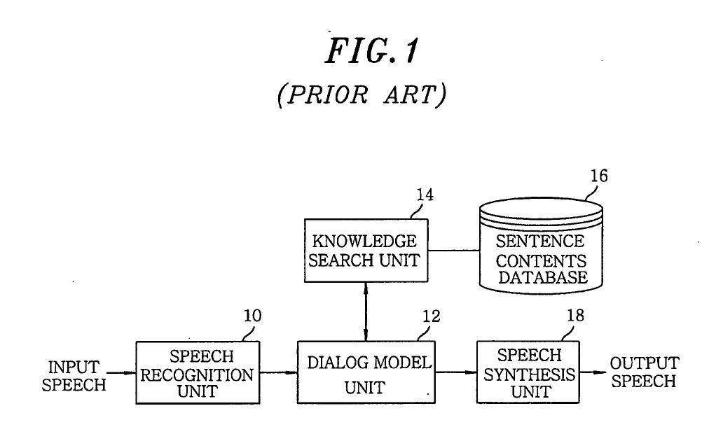

### DETAILED DESCRIPTION OF THE EMBODIMENTS

Hereinafter, embodiments of the present invention will be described in detail with reference to the accompanying drawings.

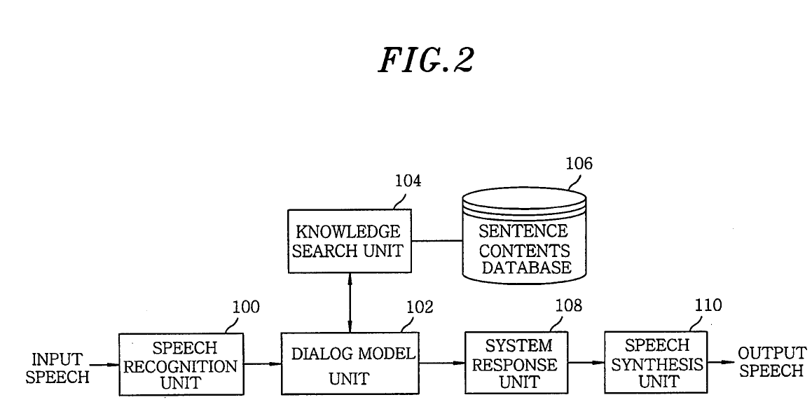

FIG. 2 provides a schematic view showing a spoken dialog system in accordance with the present invention.

As shown in FIG. 2, the spoken dialog system in accordance with an embodiment of the present invention includes a speech recognition unit 100, a dialog model unit 102, a knowledge search unit 104, a sentence contents database 106, a system response unit 108, and a speech synthesis unit 110.

The speech recognition unit 100 performs a speech recognition and delivers a character sequence corresponding to the recognized speech to the dialog model unit 102. The speech recognition includes a process of detecting a user's input speech; a process of amplifying the speech detected to a specific level; a process of extracting feature parameters of the speech; and other processes necessary to perform the speech recognition.

The dialog model unit 102 delivers the character sequence recognized by the speech recognition unit 100 to the knowledge search unit 104 to receive sentence contents searched therethrough and establishes a dialog model by using the sentence contents obtained by the knowledge search unit 104. Also, the dialog model unit 102 attains a basic sentence by using the sentence contents received from the knowledge search unit 104.

The sentence contents database 106 stores therein the sentence contents to be used in a user response sentence, for example, a weather search, a schedule management, a news search, a TV program guide, an email management, etc.

The knowledge search unit 104 searches the sentence contents stored in the sentence contents database 106 to be matched with the character sequence received from the dialog model unit 102.

The system response unit 108 generates an output sentence by initially generating a plurality of candidate sentences, then selecting one of the candidate sentences which is determined to be harmonized with the user's input speech or expressing the situation of the system, and finally assigning an ending form of the sentence and an intonation pattern to the selected sentence. Further, the output sentence is provided to the speech synthesis unit 110. If the system response unit 108 does not select one of the candidate sentences harmonizing with the user's input speech or expressing the situation of the system, it delivers the basic sentence as the output sentence to the speech synthesis unit 110.

The speech synthesis unit 110 converts the output sentence generated by the system response unit 108 into an output speech to provide it to the user. Further, if the speech synthesis unit 110 receives the basic sentence from the system response unit 108, it converts the received basic sentence into the output speech and produces the same as an output.

A difference between the spoken dialog system in accordance with the present invention and the conventional spoken dialog system is that the former is provided with the system response unit 108 whereas the latter is not. Here, the system response unit 108 generates the output sentence which is, as mentioned above, determined to be harmonized with the user's input speech or expressing the situation of the system. In this manner, the spoken dialog system in accordance with the present invention realizes a natural dialog between the user and the system.

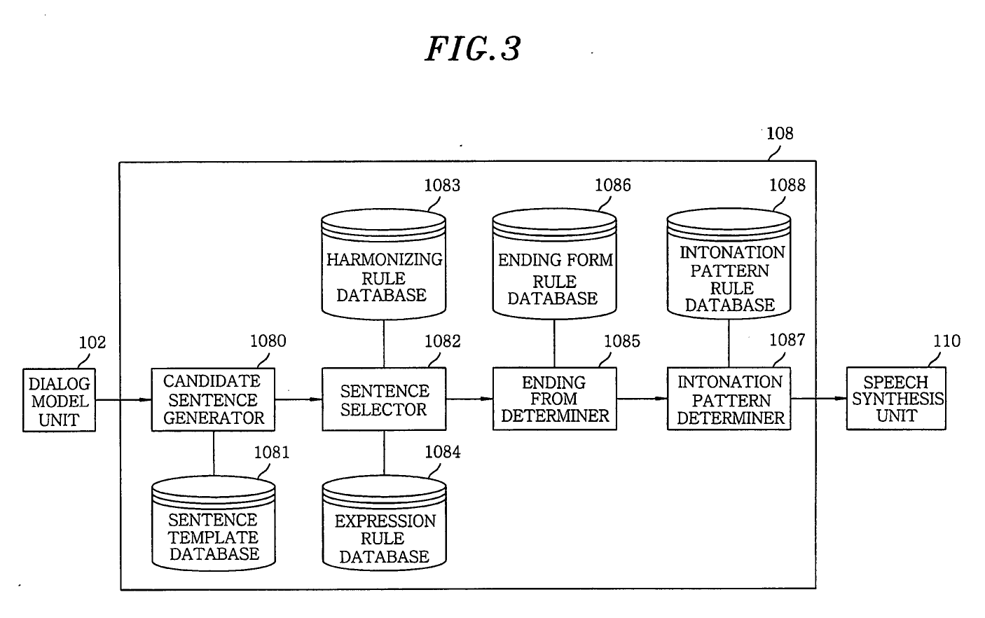

FIG. 3 describes a detail view showing a system response unit 108 of the spoken dialog system in accordance with the present invention.

As shown in FIG. 3, the system response unit 108 includes a candidate sentence generator 1080; a sentence template database 1081; a sentence selector 1082; a harmonizing rule database 1083; an expression rule database 1084; an ending form determiner 1085; an ending form rule database 1086; an intonation pattern determiner 1087; and an intonation pattern rule database 1088.

The candidate sentence generator 1080 generates the candidate sentences by using the dialog model and the sentence template database 1081.

The sentence template database 1081 stores therein the candidate sentences to be provided to the candidate sentence generator 1080.

The sentence selector 1082 selects one of the candidate sentences, the one selected being harmonized with the user's input speech or expressing the situation of the system, and delivers the selected sentence to the ending form determiner 1085.

The harmonizing rule database 1083 stores therein user speech harmonizing rules to be provided to the sentence selector 1082.

The expression rule database 1084 stores therein system situation expression rules to be provided to the sentence selector 1082. The sentence selector 1082 uses the user system situation expression rules when it selects the sentence which expresses the situation of the system.

The ending form determiner 1085 assigns a situation dependent ending form of the sentence to the sentence selected by the sentence selector 1082, and delivers the selected sentence, to which the ending form of the sentence is assigned, to the intonation pattern determiner 1087.

The ending form rule database 1086 stores therein ending form changing rules to be provided to the ending form determiner 1085. The ending form determiner 1085 uses the ending form changing rules when it assigns the ending form of the sentence to the selected sentence.

The intonation pattern determiner 1087 assigns a situation dependent intonation pattern to the sentence received from the ending form determiner 1085, and delivers the sentence as the output sentence to the speech synthesis unit 110.

The intonation pattern rule database 1088 stores therein intonation pattern changing rules to be provided to the intonation pattern determiner 1087. The intonation pattern determiner 1087 uses the intonation pattern changing rules when it assigns the intonation pattern to the selected sentence.

Accordingly, the system response unit 108 of the spoken dialog system in accordance with the present invention realizes a natural dialog between the user and the system by generating the output sentence in the following manner. First, the candidate sentence generator 1080 generates the plurality of candidate sentences, one of which will be output to the user. Thereafter, the sentence selector 1082 selects one of the candidate sentences which is determined to be harmonized with the user's input speech or expressing the situation of the system. Further, the ending form determiner 1085 and the intonation pattern determiner 1087 assign the situation dependent ending form of the sentence and the situation dependent intonation pattern, respectively, to the selected sentence.

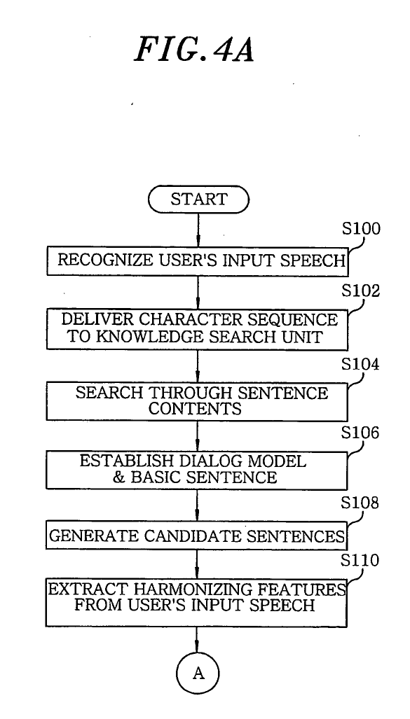

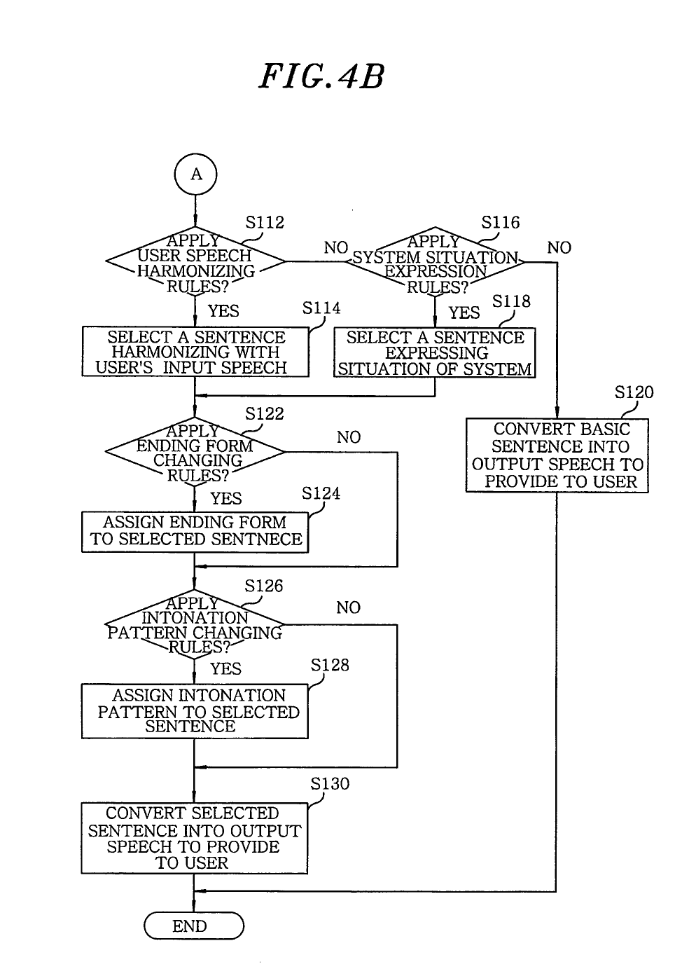

FIGS. 4A and 4B depict a flow chart showing a system response method of the spoken dialog system in accordance with the present invention.

With reference to FIGS. 4A and 4B along with FIGS. 2 and 3, a response method in the spoken dialog system according to another embodiment of the present invention will be described as follows.

First, the speech recognition unit 100 performs a speech recognition and delivers a character sequence corresponding to a user's input speech to the dialog model unit 102 (S100). The speech recognition includes a process of detecting the user's input speech; a process of amplifying the speech detected to a specific level; a process of extracting feature parameters from the speech; and other processes necessary to perform the speech recognition.

The dialog model unit 102 delivers the character sequence recognized by the speech recognition unit 100 to the knowledge search unit 104 (S102). Thereafter, the knowledge search unit 104 searches through the sentence contents stored in the sentence contents database 106 to find a match for the character sequence, and delivers the searched sentence contents to the dialog model unit 102 (S104).

Then, the dialog model unit 102 establishes a dialog model and a basic sentence by using the sentence contents searched by the knowledge search unit 104 (S106). The sentence contents used in obtaining the dialog model includes, for example, service areas (a weather forecast, a schedule, news, a TV program guide, an email, etc.), speech acts/system actions, concept strings (a person, a place, a time, the number of times, a date, a genre, a program, etc.), and search results.

In the system response unit 108, the candidate sentence generator 1080 generates (extracts) the plurality of candidate sentences from the sentence template database 1081 by using the dialog model set by the dialog model unit 102 (S108).

The sentence selector 1082 extracts harmonizing features from the user's input speech by using the user speech harmonizing rules stored in database 1083 (S110). The harmonizing rule database 1083 stores therein data of harmonizing features (i.e., harmonizing rules), e.g., such as a table for difficulty levels of words; a table for adverbs which expresses intensity of meaning; a table for emotional interjections, emotional adjectives, emotional nouns, and the like.

After that, the sentence selector 1082 determines whether or not to apply the user speech harmonizing rules in sentence selection (S112).

If the sentence selector 1082 determines to apply the user speech harmonizing rules in a sentence selection, the sentence selector 1082 selects a sentence, which has the harmonizing features extracted (i.e., harmonizes with the user's input speech), from the candidate sentences (S114).

Table 1 shows examples for selecting an optimal sentence among the candidate sentences by using the user speech harmonizing rules (e.g., six rules as in Table 1).

TABLE 1

| | Rules | Examples |
|---|---|---|
| 1 | Select a sentence which has the most | User> How is the weather today? |
| | similar sentence pattern to the user's | System> Today's weather is nice. |
| | input speech. | |
| 2 | Select a sentence which uses words | User> I'm not feeling well. What |
| | with difficulty levels similar to or | should I do? |
| | easier than those used in the user's | System> Do not exercise and have |
| | input speech. | yourself a good sleep. |
| | | User> I am physically fragile. What |
| | | should I do about it? |
| | | System> Try to avoid any exercise and |
| | | have yourself a good sleep. |
| 3 | Select a sentence which harmonizes | User> Well done. |
| | with the intensity of the user's input | System> Thank you. |
| | speech. | User> You were excellent today. |
| | | System> Don't mention it. It was my |
| | | pleasure having you. |
| 4 | Select a sentence in which response | User> I am planning to play a round of |
| | words appropriate to the user's input | golf tomorrow. What would be the |
| | speech (e.g., ‘yes’, ‘oh, yes’, ‘no’, | weather like tomorrow? |
| | or the like) are inserted. | System> Oh yes, it is going to be |
| | | raining tomorrow. |
| | | User> No appointment scheduled for |
| | | tomorrow? |
| | | System> Yes, there is one in the |
| | | afternoon tomorrow. |
| 5 | Select a sentence which has an | User> The room is warm. |
| | appropriate level harmonizing with the | System> How's the temperature? |
| | intensity of the meaning. | User> The room is too warm. |
| | | System> Would you like it to be |
| | | cooler? |
| 6 | Select a sentence which is appropriate | User> Shoot. |
| | to cases in which emotional | System> What's the matter? |
| | interjections, emotional adjectives, | User> Oh no. |
| | emotional nouns, or the like are used | System> Something wrong? |
| | alone or with other sentence in the | |
| | user's input speech. | |

When the sentence selector 1082 determines not to apply the user speech harmonizing rules in the step S112, a control process proceeds to a step S110 where it is determined whether or not to apply the system situation expression rules (S116).

If it is determined to apply the system situation expression rules stored in the expression rule database 1084, in the sentence selection for the sentence selector 1082 selects a sentence which expresses the situation of the system (S118). On the contrary, if it is determined to apply none of the user speech harmonizing rules and the system situation expression rules, the system response unit 108 delivers the basic sentence as the output sentence to the speech synthesis unit 110. The speech synthesis unit 110 then converts the basic sentence into an output speech to provide to the user (S120).

Table 2 shows examples for selecting the sentence expressing the situation of the system by using the system situation expression rules (e.g., a situation where the system requests a confirmation of the user, a situation where the user requests a confirmative answer of the system, a situation where the system cannot answer, and the like).

TABLE 2

| | Rules | Examples |
|---|---|---|
| 1 | Select a sentence expressing a | User> What would be |
| | situation where the system requests | the weather like tomorrow? |
| | a confirmation of the user | System> The weather in |
| | | Daejeon-city? |
| 2 | Select a sentence expressing a | User> Have you recorded |
| | situation where the user requests a | the program? |
| | confirmative answer of the system. | System> Yes, I have |
| | | recorded thebaseball game. |
| 3 | Select a sentence expressing a | User> Tell me the next |
| | situation where the system cannot | week's TV schedule. |
| | answer (e.g., for a request | System> Nothing has |
| | naturally impossible to carry out, | been scheduled yet for |
| | for a request which can be carried | next week at the moment. |
| | out but has no answer, or for a | |
| | request for which the system has no | |
| | answer now). | |

After the sentence selector 1082 selects the sentence which harmonizes with the user's input speech or expresses the situation of the system, the ending form determiner 1085 determines whether or not to apply the ending form changing rules stored in the ending form rule database 1086 to the selected sentence (S122).

If the ending form determiner 1085 determines to apply the ending form changing rules, it assigns a situation dependent ending form of the sentence to the sentence selected (S124).

Table 3 shows examples for changing the ending form of the sentence to make a natural dialog by using the ending form changing rules. In Table 3, situations of the system are classified into a reportive, an inferential, an assertive, and an exceptional situation; and the ending form of the sentence is changed according to the respective situations.

TABLE 3

| | Conditions for Applying Rules | Situation |
|---|---|---|
| 1 | When the system outputs the output | Reportive |
| | sentence by referring to data | |
| | rather than those registered by | |
| | the user. | |
| 2 | When the system outputs a result | Inferential |
| | of an inference as an output | |
| | sentence. | |
| 3 | When the system delivers an | |
| | uncertain situation due to an | |
| | occurrence of a recognition error. | |
| 4 | When the system answers or asks | Assertive |
| | repetitively. | |
| 5 | When the system speeches a sure | |
| | answer. | |
| 6 | When the system describes the | |
| | situation of the system. | |
| 7 | When the system cannot find an | Exceptional |
| | answer. | |
| 8 | When the system needs to deny the | |
| | user's speech. | |

After the ending form determiner 1085 changes the ending form of the sentence by applying the ending form changing rules in the step S124 or determines not to apply the ending form changing rules to the sentence in the step S122, the intonation pattern determiner 1087 determines whether or not to apply the intonation pattern changing rules stored in the intonation pattern rule database 1088 to the sentence (S126). If the intonation pattern determiner 1087 determines to apply the intonation pattern changing rules, it assigns a situation dependent intonation pattern to the sentence by using the intonation pattern changing rules (S128).

Table 4 shows examples for changing the intonation pattern of the sentence by using the intonation pattern changing rules. In Table 4, the situations of the system are classified into mutual confirmation, assertion, emphasis/persuasion, and assurance/request, and the intonation pattern of the sentence is changed according to the respective situations. To be specific, Pattern symbols H (High tone), L (Low tone), and M (Middle tone, i.e., approximately middle of the High tone and the Low tone) in Table 4 confirm the K-TOBI (Korean Tone Break Indices).

TABLE 4

| | Conditions for Applying Rules | Situation | Intonation pattern |
|---|---|---|---|
| 1 | When the system generates a | Mutual | HL (High-Low) |
| | sentence (asks a question) about | confirmation | tone |
| | the old information already | | |
| | mentioned in the dialog. | | |
| 2 | When the system describes. | Assertion | ML (Middle-Low) |
| | | | tone |
| 3 | When the system denies the | Emphasis/ | LML (Low-Middle- |
| | user's speech. | Persuasion | Low) tone |
| 4 | When the system counsels. | Assurance/ | LM (Low-Middle) |
| | | Request | tone |

After the intonation pattern determiner 1087 changes the intonation pattern of the sentence by applying the intonation pattern changing rules in the step S128 or determines not to apply the intonation pattern changing rules to the sentence in the step S126, the speech synthesis unit 110 converts the selected sentence generated by the system response unit 108, and outputs it (S130).

Therefore, the system response method in the spoken dialog system in accordance with the present invention realizes a natural dialog between the user and the system by generating the output sentence, which is determined to be harmonized with the user's input speech or expressing the situation of the system, and assigning the situation dependent ending form and/or the situation dependent intonation pattern to the output sentence.

While the invention has been shown and described with respect to the embodiments, it will be understood by those skilled in the art that various changes and modifications may be made without departing from the scope of the invention as defined in the following claims.

What is claimed is:

1. A spoken dialog system, the system comprising:
a speech recognition unit for recognizing a user's input speech to generate a character sequence corresponding thereto;
a sentence contents database for storing therein a plurality of sentence contents;
a knowledge search unit for searching through the sentence contents to find a match for the character sequence, in the sentence contents database;
a dialog model unit for delivering the character sequence to the knowledge search unit to receive the sentence contents therefrom, and setting a dialog model by using the sentence contents;
a system response unit for generating an output sentence which harmonizes with the user's input speech or expresses a situation of the system; and
a speech synthesis unit for converting the output sentence into an output speech.

2. The spoken dialog system of claim 1, wherein the system response unit includes,
a sentence template database for storing therein the candidate sentences;
a candidate sentence generator for generating the candidate sentences by using the dialog model and the sentence template database;
a harmonizing rule database for storing therein user speech harmonizing rules;
an expression rule database for storing therein system situation expression rules;
a sentence selector for selecting one of the candidate sentences which is determined to be harmonized with the user's input speech or expressing the situation of the system;
an ending form rule database for storing therein ending form changing rules;
an ending form determiner for assigning an ending form to the selected sentence by using the ending form changing rules;
an intonation pattern rule database for storing therein intonation pattern changing rules; and
an intonation pattern determiner for assigning an intonation pattern to the selected sentence by using the intonation pattern changing rules.

3. The spoken dialog system of claim 2, wherein the sentence selector uses the user speech harmonizing rules when it selects the sentence which is determined to be harmonized with the user's input speech, and uses the system situation expression rules when it selects the sentence which is determined to be expressing the situation of the system.

4. The spoken dialog system of claim 3, wherein the candidate sentences includes:
a sentence which has a sentence pattern similar to the user's input speech;
a sentence which uses words with difficulty levels similar to or easier than those used in the user's input speech;
a sentence which harmonizes with the intensity of the user's input speech;
a sentence in which response words appropriate to the user's input speech are inserted;
a sentence which has an appropriate level harmonizing with the intensity of the meaning; and
a sentence which is appropriate to cases in which emotional interjections, emotional adjectives, or emotional nouns are used in the user's input speech,
wherein the user speech harmonizing rules are defined to select one of the candidate sentences.

5. The spoken dialog system of claim 3, wherein the candidate sentences includes:
a sentence expressing a situation where the system requests a confirmation of the user;
a sentence expressing a situation where the user requests a confirmative answer of the system; and
a sentence expressing a situation where the system cannot answer,
wherein the system situation expression rules are, defined to select one of the candidate sentences.

6. The spoken dialog system of claim 2, wherein the situation of the system includes a reportive, an inferential, an assertive, and an exceptional situation, and the ending form changing rules assign ending forms according to the respective situations.

7. The spoken dialog system of claim 2, wherein the situation of the system includes mutual confirmation, assertion, emphasis/persuasion, and assurance/request, and the intonation pattern changing rules assign intonation patterns depending on the respective situations.

8. The spoken dialog system of claim 1, wherein the dialog model unit sets a basic sentence by using the information received from the knowledge search unit,
and the system response unit delivers the basic sentence to the speech synthesis unit if it does not generate the output sentence which harmonizes with the user's input speech or expresses a situation of the system, and the speech synthesis unit converts the basic sentence into the output speech.

9. A method for generating a response in a spoken dialog system, the method comprising the steps of:
recognizing a user's input speech to generate a character sequence corresponding thereto;
searching through sentence contents to find a match for the character sequence;
setting a dialog model by using the sentence contents searched;
generating an output sentence which harmonizes with the user's input speech or expresses a situation of the system; and
converting the output sentence into an output speech.

10. The response method of claim 9, wherein the step for generating the output sentence includes:
generating a plurality of candidate sentences by using the dialog model;
selecting one of the candidate sentences which harmonizes with the user's input speech or expresses a situation of the system;
assigning an ending form of the sentence to the selected sentence; and
assigning an intonation pattern to the selected sentence.
